(19) United States
(12) Patent Application Publication
(10) Pub. No.: US 2025/0012381 A1
(43) Pub. Date: Jan. 9, 2025

(54) PASS THROUGH ASSEMBLY CONFIRMATION QUICK CONNECTOR

(71) Applicant: A. RAYMOND ET CIE, Grenoble (FR)

(72) Inventor: Manuel Martinez, Shelby Township, MI (US)

(21) Appl. No.: 18/710,924

(22) PCT Filed: Nov. 18, 2021
(86) PCT No.: PCT/IB2021/060713

§ 371 Date: May 16, 2024

(51) Int. Cl. F16L 5/02; F16L 5/06; F16L 37/00

(52) U.S. Cl. CPC F16L 5/027; F16L 5/06; F16L 37/008; F16L 2201/10

(57) ABSTRACT

A pass through assembly confirmation quick connector comprising a pass through tube (12) having a cylindrical outer surface (20), a tubular locking ring (14) disposable on the outer surface of the pass through tube, a twist-lock mount (16) releasably connecting the pass through tube and the locking ring, and a confirmation ring (18) releasably connected to the locking ring, wherein twisting the locking ring relative to the pass through tube moves the locking ring between an unlocked position and a locked position, wherein the confirmation ring secures the locking ring in the locked position.

### FIELD OF THE INVENTION

The disclosure generally relates to quick connectors and, more specifically, to quick connectors providing visible indication of proper and/or complete installation during use.

### BACKGROUND OF THE INVENTION

Quick connectors are connector assemblies that allow for convenient, quick, fluid-tight connections between two or more pipes, tubes, or similar components. Quick connectors are commonly used in the automotive industry to connect tubing used in engine cooling circuits or, more recently, in cooling circuits used to cool batteries of electric or hybrid vehicles. Quick connectors typically include a female connector for receiving a male connector, or a male connector for receiving a female connector. In operation, when fully disposed within the female connector, the male connector is reversibly locked in position allowing for leak-free fluid communication between a first tube in fluid communication with the female connector and a second tube in fluid communication with the male connector. Unfortunately, many conventional quick connectors suffer from numerous drawbacks associated with locking together the components to be connected, resulting in failed connections, depressurizations, and leaks. For example, fluid connector tubes that pass through a wall of a sealed enclosure must be securely fit around the opening in the wall to maintain the seal. Improper installation of the pass through connector may lead to leaks in the enclosure.

### BRIEF SUMMARY

A pass through assembly confirmation quick connector is provided. The pass through assembly confirmation quick connector includes a pass through tube having a cylindrical outer surface, a tubular locking ring disposable on the outer surface of the pass through tube, a twist-lock mount releasably connecting the pass through tube and the locking ring, and a confirmation ring releasably connected to the locking ring. Twisting the locking ring relative to the pass through tube moves the locking ring between an unlocked position and a locked position. The confirmation ring secures the locking ring in the locked position.

In specific embodiments, the twist-lock mount includes at least one locking member projecting from the outer surface of the pass through tube, and at least one female receptor disposed on an inner surface of the locking ring. Each female receptor corresponds to one of the at least one locking member, and each locking member is received in its corresponding female receptor.

In particular embodiments, each female receptor includes an inlet slot and a ramp adjacent the slot.

In particular embodiments, the assembly includes a pair of the locking members circumferentially opposed on the outer surface of the pass through tube, and a corresponding pair of the female receptors circumferentially opposed on the inner surface of the locking ring.

In certain embodiments, the assembly includes two pairs of the locking members and two pairs of the female receptors. One pair of locking members is circumferentially offset 90 degrees from the other pair of locking members, and the one pair of locking members is spaced from the other pair of locking members in an axial direction of the pass through tube. Also, one pair of female receptors is circumferentially offset 90 degrees from the other pair of female receptors.

In certain embodiments, the locking ring includes a first annular edge at one end and a second annular edge at an opposite end. The inlet slots of the female receptors are formed in the first annular edge, the ramps of the one pair of female receptors are proximate the first annular edge, and the ramps of the other pair of female receptors are proximate the second annular edge.

In specific embodiments, the confirmation ring includes opposite first and second surfaces, as well as an inner edge and an outer edge. The first surface includes a pair of circumferentially opposed clips along the outer edge and extending in an axial direction away from the first surface.

In particular embodiments, the locking ring includes two circumferentially opposed clip receivers. The clips of the confirmation ring are connectable to the clip receivers of the locking ring to secure the confirmation ring to the locking ring.

In particular embodiments, the confirmation ring includes a pair of circumferentially opposed verification tabs along the outer edge and extending in an axial direction away from the first surface.

In certain embodiments, the locking ring includes two circumferentially opposed tab receivers. The verification tabs of the confirmation ring are insertable into the tab receivers of the locking ring.

In particular embodiments, the confirmation ring includes a pair of circumferentially opposed stop tabs along the inner edge and extending in an axial direction away from the first surface.

In certain embodiments, the stop tabs of the confirmation ring are insertable into a portion of the twist-lock mount to prevent the locking ring from moving from the locked position to the unlocked position.

In specific embodiments, the confirmation ring is disk-shaped.

In specific embodiments, the pass through tube includes an annular flange extending radially from the cylindrical outer surface, and a sealing ring is disposed adjacent the annular flange.

In specific embodiments, a cooperative indication surface is partly formed on the locking ring and partly formed on the confirmation ring. The part of the indication surface on the locking ring is adjacent to and aligned with the part of the indication surface on the confirmation ring when the confirmation ring is connected to the locking ring.

In specific embodiments, the pass through tube includes connectors at each end. A first quick connect component is connected to the connectors at one end, and a second quick connect component is connected to the connectors at the other end.

A pass through assembly is also provided. The assembly includes the pass through assembly confirmation quick connector. The pass through tube of the assembly is inserted into an opening in a surface member having first and second sides, the opening being sized to receive the pass through tube. The locking ring is disposed on the pass through tube in the unlocked position. Twisting the locking ring moves the locking ring to the locked position and draws the locking ring against the first side of the surface member and simultaneously urges a portion of the pass through tube against the second side of the surface member.

In specific embodiments, the surface member is one or more of a housing wall, a boundary wall, and a mounting plate.

A method for establishing fluid communication through a surface member having first and second sides and including an opening sized to receive the pass through tube is also provided. The method includes inserting the pass through tube into the opening such that an annular flange extending radially from the cylindrical outer surface of the pass through tube abuts against the second side of the surface member. The method may further include sliding the locking ring onto the pass through tube. The method may further include twisting the locking ring approximately 90 degrees relative to the pass through tube to move the locking ring from the unlocked position to the locked position, drawing the locking ring against the first side of the surface member and simultaneously urging the annular flange of the pass through tube against the second side of the surface member to tightly connect the pass through tube to the opening in the surface member. The method may further include connecting the confirmation ring to the locking ring to secure the locking ring in the locked position when the locking ring is in the locked position.

In specific embodiments, a cooperative indication surface is partly formed on the locking ring and partly formed on the confirmation ring. The method may further include the part of the indication surface on the locking ring being adjacent to and aligned with the part of the indication surface on the confirmation ring when the confirmation ring is connected to the locking ring. The indication surface is then readable by a reader and indicates that the locking ring is securely in the locked position.

### DESCRIPTION OF THE DRAWINGS

Various advantages and aspects of this disclosure may be understood in view of the following detailed description when considered in connection with the accompanying drawings, wherein:

FIG. 1 shows a perspective view of a pass through quick connector (QC) assembly in accordance with some embodiments of the disclosure;

FIG. 2 shows a side cross-sectional view of the pass through QC assembly of FIG. 1;

FIG. 3 shows a perspective view of a pass through tube of the pass through QC assembly of FIG. 1;

FIG. 4A shows a perspective view of a locking ring of the pass through QC assembly of FIG. 1;

FIG. 4B shows another perspective view of the locking ring;

FIG. 4C shows another perspective view of the locking ring;

FIG. 5A shows a perspective view of a confirmation ring of the pass through QC assembly of FIG. 1;

FIG. 5B shows another perspective view of the confirmation ring;

FIG. 6 shows a partial perspective view of the pass through QC assembly having an indication surface in accordance with particular embodiments of the disclosure;

FIG. 7 shows a perspective view of the pass through QC assembly of FIG. 1 connected to quick connect components in accordance with particular embodiments of the disclosure;

FIG. 8 shows a side perspective view of a pass through QC assembly in accordance with certain embodiments of the disclosure;

FIG. 9 shows a rear perspective view of a pass through QC assembly of FIG. 8;

FIG. 10 shows a perspective view of a surface member corresponding to the pass through QC assembly of FIG. 8; and

FIG. 11 shows a partial perspective view of a pass through tube of the pass through QC assembly of FIG. 8 inserted into the surface member.

### DETAILED DESCRIPTION OF THE INVENTION

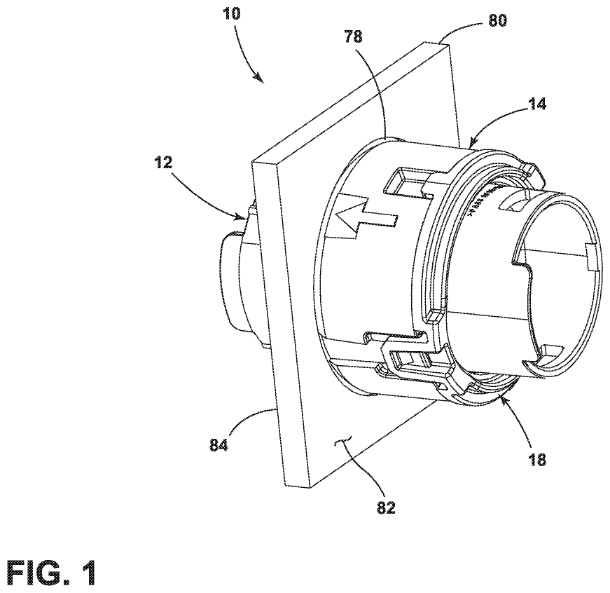

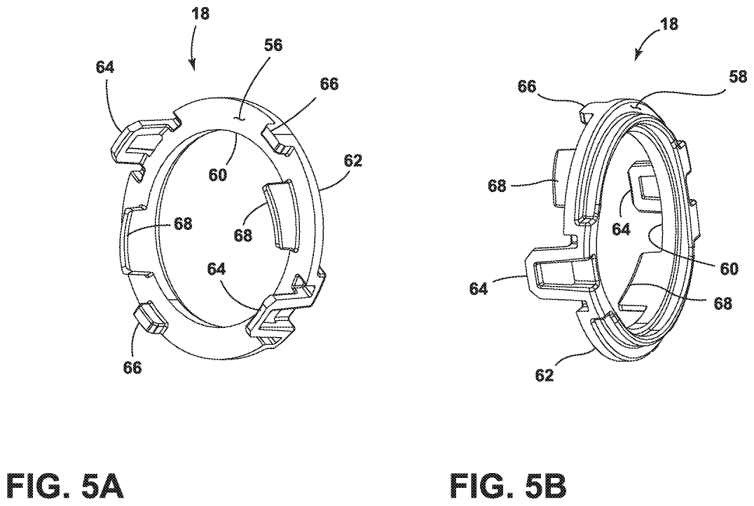

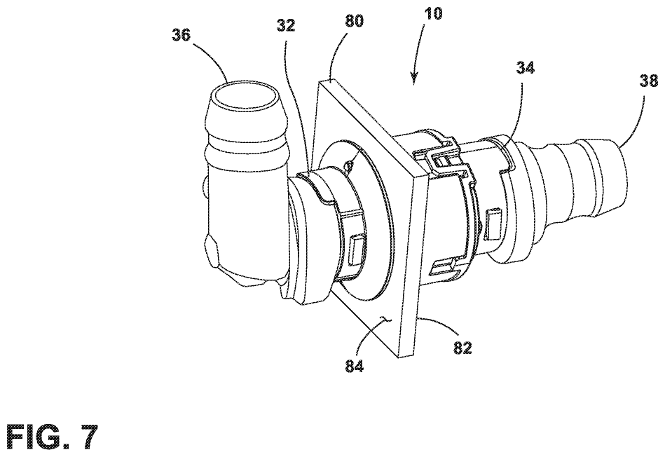

A quick connector assembly is provided. Referring to FIGS. 1-7 wherein like numerals indicate corresponding parts throughout the several views, the quick connector assembly (also referred to as the connector assembly, or QC assembly herein) is illustrated and generally designated at 10. Certain features of the quick connector assembly 10 are functional, but can be implemented in different aesthetic configurations. The quick connector assembly 10 includes a pass through tube 12, a locking ring 14, a twist-lock mount 16, and a confirmation ring 18.

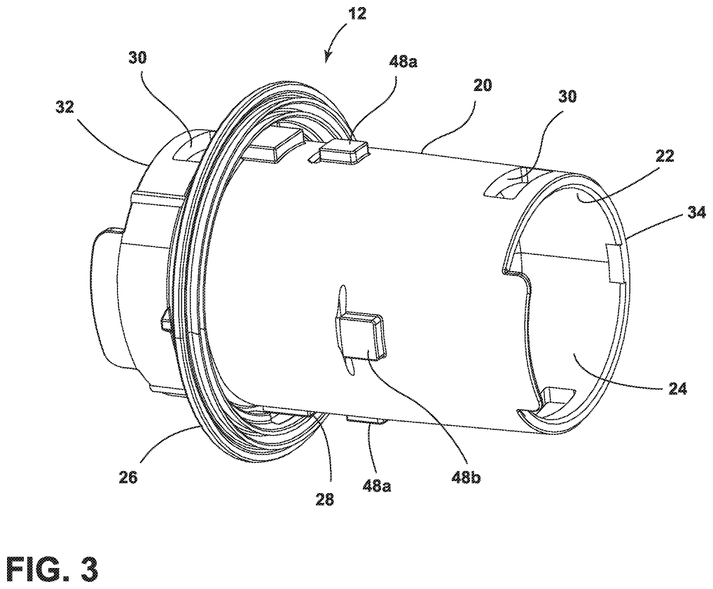

As shown particularly in FIG. 3, the pass through tube 12 has a generally tubular, elongated shape, and includes a cylindrical outer (exterior) surface 20 and an inner (interior) surface 22 that generally defines a fluid passageway 24 (i.e., an open bore 24), alternatively referred to as the passageway 24. The passageway 24 is cylindrical in cross-section or oval or square in cross-section. In particular embodiments, the fluid passageway 24 includes a minimum diameter equal to from 4 to 70 mm, alternatively from 8 to 50 mm. The pass through tube 12 may be I-shaped (straight), or may be L-shaped (90 degree elbow), another angled shape (e.g. 45 degree elbow), T-shaped, Y-shaped, or the like. The pass through tube 12 also includes an annular flange 26 extending radially from the cylindrical outer surface 20. A sealing ring 28 such as an O-ring or similar is adjacent the annular flange 26, for sealing the gap between the pass through tube 12 and a surface against which the pass through tube is mounted as described in more detail below. Connectors 30 are disposed at both the first end 32 and the second end 34 of the pass through tube 12. A first quick connect component 36 can be connected to the connectors at the first end 32, and a second quick connect component 38 can be connected to the connectors at the second end 34.

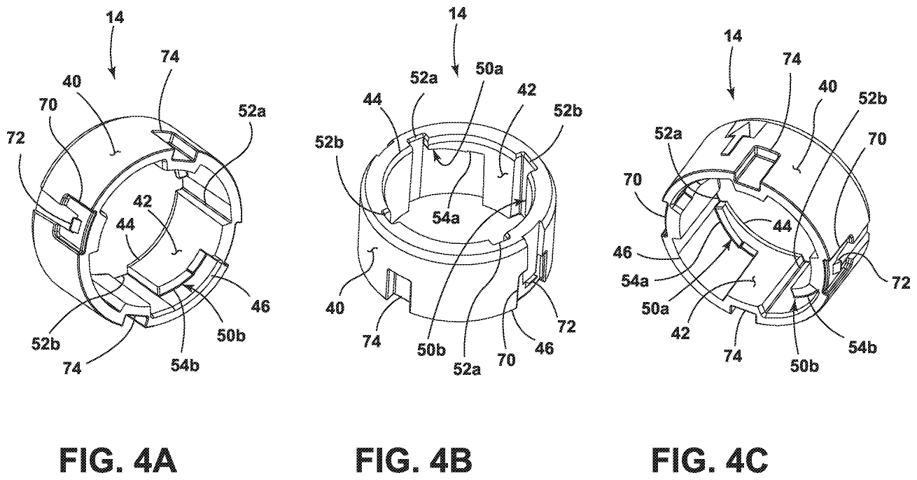

As shown particularly in FIGS. 4A-C, the locking ring 14 has a generally tubular, ring-like shape and includes a cylindrical outer (exterior) surface 40, an inner (interior) surface 42, a first annular edge 44 at one end, and a second annular edge 46 at an opposite end. The inner diameter of the locking ring 14 is sized to have approximately the same or slightly larger length than the outer diameter of the pass through tube 12, such that the locking ring may be slid onto and disposed about the outer surface 20 of the pass through tube.

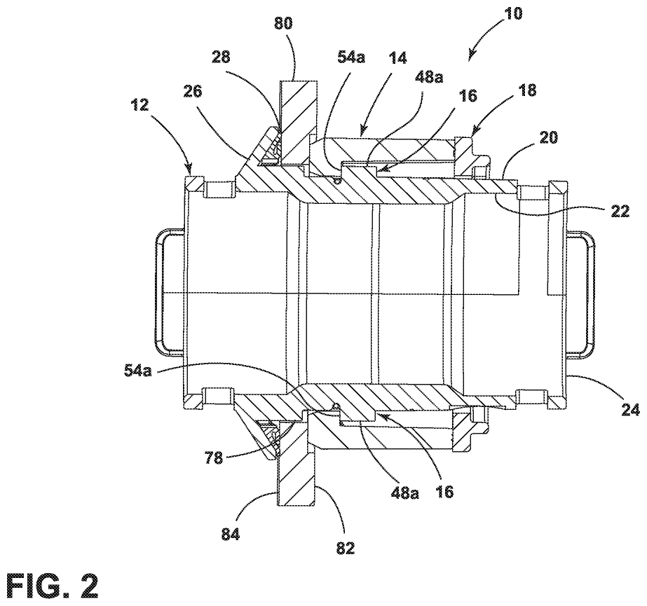

The twist-lock mount 16 releasably connects the pass through tube 12 and the locking ring 14, and is generally defined by features on both the pass through tube and the locking ring. Particularly, as shown in FIGS. 2 and 3, the twist-lock mount 16 includes at least one locking member 48a, 48b projecting from the outer surface 20 of the pass through tube 12. Each locking member 48a, 48b is generally prismatic in shape and may have, for example, a rectangular cross-section. In certain embodiments, the twist-lock mount 16 includes four locking members 48a, 48b (two pairs of two locking members). The two locking members 48a of one of the pairs are circumferentially opposed to each other, i.e. spaced approximately 180 degrees apart from each other in a circumferential direction around the circumference of the pass through tube 12. The two locking members 48b of the other pair are also spaced approximately 180 degrees apart from each other in the circumferential direction (one of the two locking members 48b is not visible in FIG. 3 but it should be understood from the description that it is located on the “back” side of the tube 12 180 degrees opposite from the visible locking member 48b, in the same manner that the locking members 48a can be seen as being 180 degrees apart around the circumference of the tube 12). Further, the one pair of locking members 48a is circumferentially offset 90 degrees from the other pair of locking members 48b and is spaced from the other pair of locking members 48b in an axial direction of the pass through tube 12 (the axial direction being parallel to a central axis of the pass through tube such that the one pair of locking members 48a is closer to the first end 32 of the pass through tube than the other pair 48b).

The twist-lock mount 16 also includes at least one female receptor 50a, 50b disposed on the inner surface 42 of the locking ring 14 shown in FIGS. 4A-C. Each female receptor 50a, 50b corresponds to one of the locking members 48a, 48b, and as such the number of female receptors is equal to the number of locking members. In certain embodiments, the twist-lock mount 16 includes four female receptors 50a, 50b (two pairs of two receptors). The two receptors 50a of one of the pairs are circumferentially opposed to each other, i.e. spaced approximately 180 degrees apart from each other in a circumferential direction around the circumference of the locking ring 14. The two receptors 50b of the other pair are also spaced approximately 180 degrees apart from each other in the circumferential direction. Further, the one pair of female receptors 50a is circumferentially offset 90 degrees from the other pair of female receptors 50b. Each female receptor 50a, 50b includes an inlet slot 52a, 52b and a ramp (sloped surface) 54a, 54b adjacent and connected to the slot. The inlet slots 52a, 52b of the female receptors 50a, 50b are formed in the first annular edge 44 of the locking ring 14. The ramps 54a of the one pair of female receptors 50a are proximate the first annular edge 44 of the locking ring 14, while the ramps 54b of the other pair of female receptors 50b are proximate the second annular edge 46 of the locking ring.

To connect the locking ring 14 to the pass through tube 12, the locking ring is slid onto the pass through tube with the first annular edge 44 of the locking ring facing the pass through tube and hence the inlet slots 52a, 52b of the female receptors 50a, 50b facing the locking members 48a, 48b of the pass through tube. The female receptors 50a, 50b are aligned with the locking members 48a, 48b by rotating the locking ring 14 on the pass through tube 12 until the inlet slots 52a of the two female receptors 50a having the ramps 54a proximate to the first annular edge 44 of the locking ring 14 are in the same circumferential position as the locking members 48a that are closer to the first end 32 of the pass through tube 12. In this configuration, the inlet slots 52b of the two female receptors 50b having the ramps 54b proximate the second annular edge 46 of the locking ring 14 are aligned with the locking members 48b that are farther from the first end 32 of the pass through tube 12. The locking ring 14 is then slide farther onto the pass through tube 12 so that each locking member 48a, 48b is received in the inlet slot 52a, 52b of its corresponding female receptor 50a, 50b. This position of the locking ring 14 may be referred to as an unlocked position. Once the locking members 48a, 48b are fully inserted into the inlet slots 52a, 52b, the locking ring 14 is twisted approximately 90 degrees (one quarter turn) relative to the pass through tube 12 to move the locking ring from the unlocked position to a locked position. As the locking ring 14 is rotated relative to the pass through tube 12, the ramps 54a, 54b of the receptors 50a, 50b forcibly contact the locking members 48a, 48b, thereby urging the first annular edge 44 of the locking ring forward towards the annular flange 26 of the pass through tube 12 as described in more detail below.

When and only when the locking ring 14 is properly connected to the pass through tube 12 and properly disposed in the locked position, the confirmation ring 18 can be releasably connected to the locking ring. The confirmation ring 18 is generally disk-shaped having a generally planar, circular shape with a concentric circular void space in its center portion. The confirmation ring 18 includes a first surface 56, an opposite second surface 58, an inner edge 60, and an outer edge 62. A pair of circumferentially opposed clips 64 are disposed along the outer edge 62 of the confirmation ring 18 and extend in an axial direction away from the first surface 56. The clips 64 may generally have a U-shape with the open portion of the U facing in the same direction as the second surface 58 of the confirmation ring 18. A pair of circumferentially opposed verification tabs 66 are also disposed along the outer edge 62 and extend in an axial direction away from the first surface 56. Additionally, a pair of circumferentially opposed stop tabs 68 are disposed along the inner edge 60 of the confirmation ring 18 and extend in an axial direction away from the first surface 56.

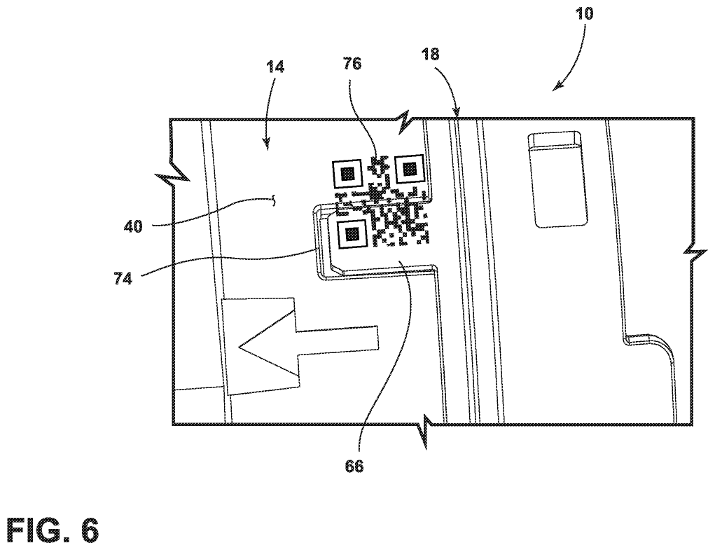

The locking ring 14 includes two circumferentially opposed clip receivers 70 that correspond to the clips 64 of the confirmation ring 18. Each clip receiver 70 is generally formed by a recess in the outer surface 40 of the locking ring 14 having a retaining element 72 such as a nub, barb, protrusion (which may conform to any of various geometries including cuboid, prismatic, diamond, triangular, or pyramidal), or dimple (e.g. a hemispherical dimple) extending from the surface of the recess. The clips 64 of the confirmation ring 18 are connectable to the clip receivers 70 of the locking ring 14 by positioning the clips in the clip receivers 70 and snapping the edge of each clip over the corresponding retaining element 72 to secure the confirmation ring to the locking ring. The locking ring 14 also includes two circumferentially opposed tab receivers 74. The tab receivers 74 may be offset 90 degrees in the circumferential direction from the clip receivers 70. Each tab receiver 74 is generally formed by a recess in the outer surface 40 of the locking ring 14 that generally corresponds in shape to the verification tabs 66. When the clips 64 are connected to the clip receivers 70, the verification tabs 66 of the confirmation ring 18 are inserted into the tab receivers 74 of the locking ring 14, and the verification tabs may be used to confirm that the locking ring 14 is properly secured in the locked position by the confirmation ring 18. Specifically, in certain embodiments shown for example in FIG. 6, a cooperative indication surface 76 is partly formed on the locking ring 14 and partly formed on the confirmation ring 18. For example, part of the indication surface 76 is formed on one of the verification tabs 66 of the confirmation ring 18, and the other part of the indication surface 76 is formed on the outer surface 40 of the locking ring 14 at a position adjacent to the corresponding tab receiver 74. When the confirmation ring 18 is connected to the locking ring 14, the verification tab 66 is inserted into the tab receiver 74 and the part of the indication surface 76 on the locking ring 14 is adjacent to and aligned with the part of the indication surface 76 on the verification tab 66. Thus, the indication surface 76 is only complete in this assembled configuration, and can only be observed or read when the locking ring 14 is in the locked position and the confirmation ring 18 is connected to lock the locking ring in place. Reading of the complete indication surface 76 thereby confirms that the assembly 10 is properly assembled and locked.

In various embodiments, the indication surface 76 may be any of various colors including yellow, green, red, white, blue, black, orange, purple, or any of various other colors including various hues obtained through mixing of various pigments or dyes corresponding to such colors or any of various other colors known in the art. The indication surface 76 may include reflective tape disposed thereupon or a sticker or a printing displaying a pattern, color, a bar code, reflective material, or alphanumeric label or message. In certain embodiments, the indication surface 76 is so colored as to be conspicuously visible against the exterior surface of the locking ring 14 and/or the confirmation ring 18. In various embodiments, the indication surface 76 is of a different color than the locking ring 14 and/or the confirmation ring 18.

In some embodiments, the indication surface 76 includes a code, such as a one-dimensional barcode (e.g. UPC code, EAN code, code 39, code 128, ITF, code 93, codabar, GS1 databar, MSI Plessey, etc.), a two-dimensional barcode (e.g. QR code, datamatrix code, PDF417, AZTEC, etc.), a holographic code, a human-readable alpha-numeric code, other codes known in the art and interpretable by machine and/or human. Additional examples of such codes include linear bar codes such as those known or otherwise characterized as Australia Post barcode, Codabar, Code 25-Non-interleaved 2 of 5, Code 25 Interleaved 2 of 5, Code 11, Farmacode (i.e., Code 32), Code 39, Code 49, Code 93, Code 128, CPC binary, EAN 2, EAN 5, EAN-8, EAN-13, GS1-128, GS1 DataBar, ITF-14, JAN, Japan Post bardcode, KarTrak ACI, MSI, Pharmacode, PLANET, Plessey, PostBar, POSTNET, RM4SCC/KIX, RM Mailmark L, Telepen, or Universal Product Code, matrix bar codes such as those known or otherwise characterized as AR code, Aztec Code, BEEtag, Bee Tagg, Bokode, Code 1, Code 16K, ColorCode, Color Construct Code, Cronto Visual Cryptogram, CyberCode, d-touch, DataGlyphs, Data Matrix, Datastrip Code, Digimarc Barcode, DotCode, DotCode A, DWCode, EZcode, Han Xin Barcode, High Capacity Color Barcode, HueCode, InterCode, JAB-Code, MaxiCode, mCode, MMCC, NexCode, PDF417, Qode, QR code, ShotCode, Snowflake Code, SPARQCode, or Trillcode, and the like, or any combination thereof.

When the confirmation ring 18 is placed on the locking ring 14 and the clips 64 of the confirmation ring are connected to the clip receivers 70 of the locking ring, the stop tabs 68 of the confirmation ring are inserted into a portion of the void space in the female receptors 50b of the twist-lock mount that are proximate the second annular edge 58 of the locking ring 14. This void space is adjacent the ramps 54b of these two female receptors 50b. The stop tabs 68 are sized so that they contact and engage the ramps 54b of these two female receptors, thereby preventing the locking ring 14 from rotating relative to the pass through tube 12 and thus securing the locking ring in the locked position by preventing the locking ring from moving out of the locked position to the unlocked position. The stop tabs 68 are also sized so that they cannot fit into the void space in the female receptors 50b unless the locking ring 14 is fully rotated on the pass through tube 12 into the locked position. Thus, the confirmation ring 18 cannot be connected to the locking ring 14 unless the locking ring is in the locked position, and thereby the confirmation ring confirms and verifies that the pass through tube 12 is locked into place by the locking ring.

In particular embodiments, as shown in FIGS. 1, 2, and 7, the pass through assembly 10 may be arranged about an opening 78 in a surface member 80 having first and second sides 82, 84. The surface member 80 may be one or more of a housing wall, a boundary wall, and a mounting plate, or similar, such as the housing wall of a vehicle battery pack enclosure. The pass through tube 12 is inserted into the opening 78 and positioned such that the annular flange 26 abuts the second side 84 of the surface member 80. The sealing ring 28 is disposed between the annular flange and the surface member 80 when the pass through tube is inserted through the opening. The locking ring 14 is then slid onto and positioned on the pass through tube 12 as described above. The locking ring 14 is subsequently twisted approximately 90 degrees relative to the pass through tube 12 to move the locking ring from the unlocked position to the locked position. The contact of the stop tabs 68 against the ramps 54b of the twist-lock connector draw the locking ring against the first side 82 of the surface member 80. The annular flange 26 of the pass through tube 12 is simultaneously urged against the second side 84 of the surface member to tightly connect the pass through tube 12 about the opening 78 in the surface member. The sealing ring 28 is compressed between the annular flange 26 and the side 84 of the surface member 80 and further ensures a tight connection between the assembly 10 and the surface member 80. In the locked position, the locking ring 14 prevents disconnection of the pass through tube 12 from the opening 78. Once the locking ring 14 is in this locked position, the confirmation ring 18 is connected to the locking ring as described above to secure the locking ring in the locked position and to prevent the pass through tube 12 from disconnecting from the opening 78 in the surface member 80. Also, the part of the indication surface 76 on the locking ring 14 is adjacent to and aligned with the part of the indication surface on the verification tab 66 of the confirmation ring 18. The “completed” indication surface 76 indicates that the locking ring is securely in the locked position and can be read by a reader to verify the secure connection. After verification of the proper connection of the pass through tube 12 to the surface member 80, the first quick connect component 36 can be connected to the connectors at the first end 32 of the pass through tube, and the second quick connect component 38 can be connected to the connectors at the other end 34. In this way, the pass through tube 12 serves as a union between two quick connect components on opposite sides of the surface member 80.

The confirmation ring 18 has the advantage of providing a visible signal as to when the locking ring 14 has been fully and properly installed on the pass through tube 12. The confirmation ring 18 provides confirmation that the pass through tube 12 is securely locked in the opening of the surface member. The indication surface 76 may include a machine-readable code, as described supra, that may be read by a scanning device to verify and document proper installation of the pass through tube 12 in the opening 78.

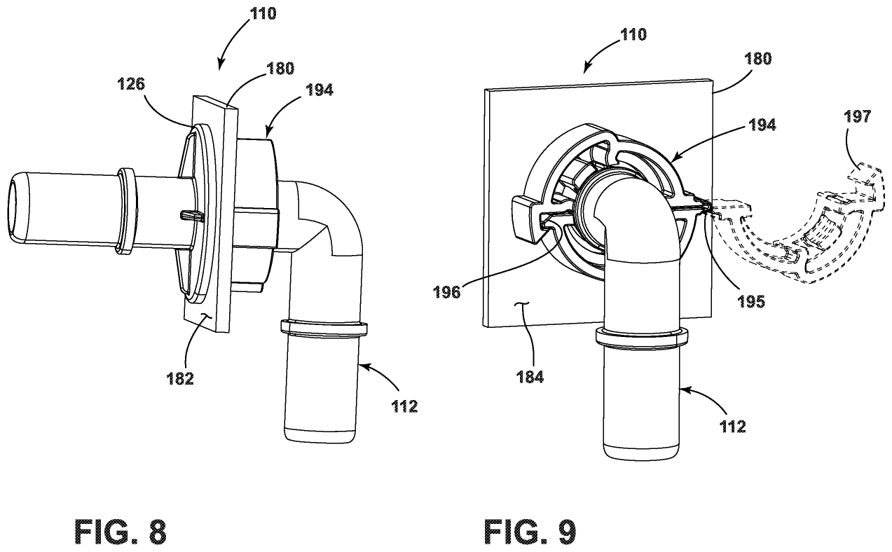

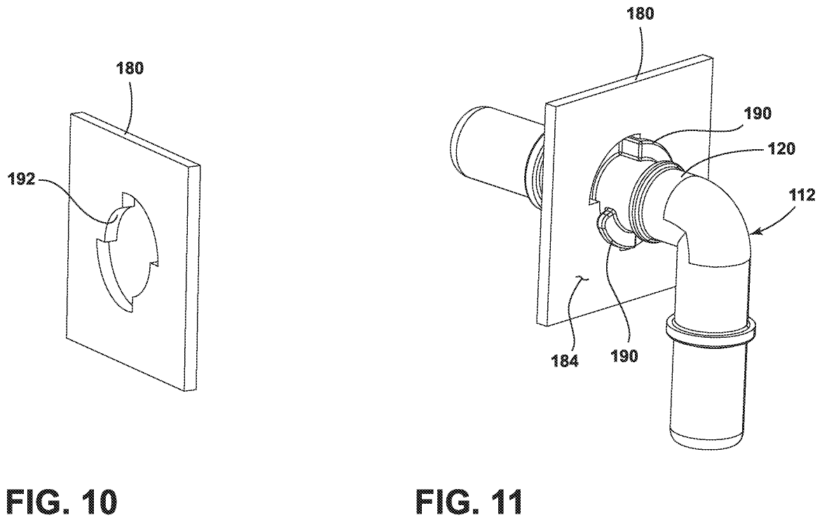

In some embodiments shown in FIGS. 8-11, the pass through tube 112 of the assembly 110 includes a pair of locking fins 190 proximate and closely spaced from the annular flange 126, such that the distance between the locking fins and the annular flange is approximately equal to the thickness of the surface member 180. The locking fins 190 extend around the exterior surface 120 of the pass through tube 112 in the circumferential direction, for example approximately 90 degrees around the exterior surface of the tube, and project outwardly in the radial direction. Correspondingly, the surface member 180 includes an opening 192 having a shape that matches the cross-section of the pass through tube taken through the locking fins 190. Specifically, the shape of the opening 192 matches a cross-section of the pass through tube 112 taken through the locking fins 190 and on a plane that is perpendicular to the axial direction of the tube. Due to this construction, when the pass through tube 112 is inserted into the opening 192, the locking fins 190 may fit through the opening if the tube is rotated about its axis to align the locking fins with the corresponding shape feature in the opening 192. Once the locking fins 190 are inserted through the opening 192, the pass through tube 112 can be rotated approximately 90 degrees (one quarter turn), moving the locking fins around the edge of the opening and to a portion of the surface member adjacent the opening. In this configuration, the locking fins 190 abut against the side 184 of the surface member 180 and cannot pass back through the opening 192, which together with the annular flange 126 on the other side 182 of the surface member, prevents the pass through tube 112 from being moved through the surface member.

Further, the locking ring 194 may be formed of two half-moon portions that are connected together by a hinge 195 at one end and a cooperative latch 196 and catch 197 at the other end. Securing and releasing the latch 196 and catch 197 allows the locking ring 194 to be opened and closed by swinging one portion of the locking ring about the hinge. In the open position, the “stationary” portion of the locking ring 194 can be placed on the pass through tube 112 on the same side of the surface member as the locking fins 190 (and therefore on the side opposite the annular flange 126) and near to the locking fins 190 and surface member 180. The other portion of the locking ring 194 is then swung towards the stationary portion in order to shut the locking ring and clamp it to the pass through tube by snapping or otherwise securing the latch 196 to the catch 197. The locking ring 194 is then pushed along the pass through tube 112 towards the surface member 180 until the locking ring slides over the locking fins 190 and abuts against the side 184 of the surface member 180. With the locking ring 194 in place, the locking fins 190 are secured and the pass through tube 112 cannot be rotated away from the locked position. In certain embodiments, a confirmation ring (not shown) and/or an assembly confirmation/verification indication surface may be located on the locking ring 194, the confirmation ring, and/or the pass through tube 112. The indication surface, as described above, confirms and verifies that the pass through tube is properly mounted and locked onto the opening 192 in the surface member 180.

The various elements of the components of the pass through assembly 10, 110 described above, e.g. the pass through tube 12, 112 the locking ring 14, 194 and the confirmation ring 18, may be manufactured from, and thus ultimately comprise, the same or different material(s), such as any one or more of the materials described below. Moreover, each element may itself comprise a combination of different materials, and thus may not comprise a homogeneous composition throughout. In certain embodiments, one or more of the components of the pass through assembly 10, 110 (e.g. the pass through tube 12, 112 the locking ring 14, 194, the confirmation ring 18, etc.) is monolithic in construction.

In general, materials suitable for use in or as the pass through tube 12, 112 the locking ring 14, 194, and the confirmation ring 18 include metals (e.g. steels, aluminums, alloys, etc.), resins (e.g. thermoset and/or thermoplastic resins), rubbers/elastomers, and combinations thereof. However, myriad materials may be used to manufacture the elements of the pass through assembly 10, 110 each typically selected as a function of availability, cost, performance/end use applications, etc. Moreover, metals, metal alloys, rubbers/elastomers, and resins are not exhaustive of suitable materials that may be used.

In certain embodiments, the pass through assembly 10, 110 comprises a resin, such as a thermoplastic and/or thermoset resin. In such embodiments, the pass through tube 12, 112 the locking ring 14, 194 and/or the confirmation ring 18 may each independently comprise an independently selected resin. Examples of suitable resins typically comprise the reaction product of a monomer and a curing agent, although resins formed of self-polymerizing monomers (i.e., those acting as both a monomer and a curing agent) may also be utilized. It is to be appreciated that such resins are conventionally named/identified according to a particular functional group present in the reaction product. For example, the term “polyurethane resin” represents a polymeric compound comprising a reaction product of an isocyanate (i.e., a monomer) and a polyol (i.e., a chain extender/curing agent). The reaction of the isocyanate and the polyol create urethane functional groups, which were not present in either of the unreacted monomer or curing agent. However, it is also to be appreciated that, in certain instances, resins are named according to a particular functional group present in the monomer (i.e., a cure site). For example, the term “epoxy resin” represents a polymeric compound comprising a cross-linked reaction product of a monomer having one or more epoxide groups (i.e., an epoxide) and a curing agent. However, once cured, the epoxy resin is no longer an epoxy, or no longer includes epoxide groups, but for any unreacted or residual epoxide groups (i.e., cure sites), which may remain after curing, as understood in the art. In other instances, however, resins may be named according to a functional group present in both the monomer and the reaction product (i.e., an unreacted functional group).

In some embodiments, the various components of the pass through assembly 10, 110 comprise material suitable for use under continuous exposure to temperatures of from −40° C. to 120° C., or from −40° C. to 135° C. and/or pressures of from 0.5 to 2 bar. In certain embodiments, one or more, alternatively all, of the various components of the pass through assembly 10, 110 comprises materials that can withstand up to 30 minutes, alternatively more than 30 minutes, of exposure to temperatures of up to 150° C. without irreversible harmful effects (e.g. melting, etc.).

With regard to composition of the particular components of the pass through assembly 10, 110 described above comprising a resin, examples of suitable resins include thermoset resins and thermoplastic resins. Examples of suitable thermoset and/or thermoplastic resins typically include polyamides (PA), such as Nylons; polyesters such as polyethylene terephthalates (PET), polybutylene terephthalates (PET), polytrimethylene terephthalates (PTT), polyethylene naphthalates (PEN), liquid crystalline polyesters, and the like; polyolefins such as polyethylenes (PE), polypropylenes (PP), polybutylenes, and the like; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones (PEK); polyetheretherketones (PEEK); polyetherketoneketones (PEKK); polyarylates (PAR); polyethernitriles (PEN); resol-type; urea (e.g. melamine-type); phenoxy resins; fluorinated resins, such as polytetrafluoroethylenes; thermoplastic elastomers, such as polystyrene types, polyolefin types, polyurethane types, polyester types, polyamide types, polybutadiene types, polyisoprene types, fluoro types, and the like; and copolymers, modifications, and combinations thereof.

With regard to composition of the particular components of the pass through assembly 10, 110 described above comprising a rubber/elastomer, examples of suitable rubber/elastomers include neoprene rubbers, buna-N rubbers, silicone rubbers, ethylene propylene diene monomer (EPDM) rubbers, natural gum rubbers, viton rubbers, natural latex rubbers, vinyl rubbers, santoprene rubbers, epichlorohydrin (ECH) rubbers, butyl rubbers, latex-free thermoplastic elastomer (TPEs), thermoplastic elastomers, hypalon rubbers, ethylene propylene rubbers, fluoroelastomer rubbers, fluorosilicone rubbers, hydrogenated nitrile rubbers, nitrile rubbers, perfluoroelastomer rubbers, polyacrylic rubbers, polychloroprenes, polyurethanes, aflas rubbers (e.g. TFE/Ps), chlorosulfonated polyethelene rubbers, styrene butadiene rubbers (SBRs), polyacrylates, ethylene acrylic rubbers, polyvinyl chloride (PVC), ethylene-vinyl acetate (EVA), and combinations thereof.

In various embodiments, any of the components of the pass through assembly 10, 110 described above may comprise a material (e.g. a resin, rubber, etc.) including a filler. Examples of suitable fillers include reinforcing fillers added for providing mechanical strength, such as inorganic fillers (e.g. fumed silica fine powder, precipitated silica fine powder, fused silica fined powder, baked silica fine powder, fumed titanium dioxide fine powder, quartz fine powder, calcium carbonate fine powder, diatomaceous earth fine powder, aluminum oxide fine powder, aluminum hydroxide powder, zinc oxide fine powder, zinc carbonate fine powder, glass fibers, etc.), organic fibers (e.g. carbon fibers), natural fibers, and the like, as well as combinations thereof. In some embodiments, at least one component of the pass through assembly 10 comprises a fiberglass.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A pass through assembly confirmation quick connector, comprising:
a pass through tube having a cylindrical outer surface;
a tubular locking ring disposable on the outer surface of the pass through tube;
a twist-lock mount releasably connecting the pass through tube and the locking ring, wherein twisting the locking ring relative to the pass through tube moves the locking ring between an unlocked position and a locked position; and
a confirmation ring releasably connected to the locking ring, the confirmation ring securing the locking ring in the locked position.

2. The pass through assembly confirmation quick connector of claim 1, wherein the twist-lock mount includes at least one locking member projecting from the outer surface of the pass through tube, and at least one female receptor disposed on an inner surface of the locking ring, each female receptor corresponding to one of the at least one locking member, and each locking member being received in its corresponding female receptor.

3. The pass through assembly confirmation quick connector of claim 2, wherein each female receptor includes an inlet slot and a ramp adjacent the slot.

4. The pass through assembly confirmation quick connector of claim 2, including a pair of the locking members circumferentially opposed on the outer surface of the pass through tube, and a corresponding pair of the female receptors circumferentially opposed on the inner surface of the locking ring.

5. The pass through assembly confirmation quick connector of claim 4, including:
two pairs of said locking members and two pairs of said female receptors;
wherein one pair of locking members is circumferentially offset 90 degrees from the other pair of locking members, and the one pair of locking members is spaced from the other pair of locking members in an axial direction of the pass through tube;
wherein one pair of female receptors is circumferentially offset 90 degrees from the other pair of female receptors.

6. The pass through assembly confirmation quick connector of claim 5, wherein the locking ring includes a first annular edge at one end and a second annular edge at an opposite end, the inlet slots of the female receptors being formed in the first annular edge, the ramps of the one pair of female receptors being proximate the first annular edge, and the ramps of the other pair of female receptors being proximate the second annular edge.

7. The pass through assembly confirmation quick connector of claim 1, wherein the confirmation ring includes opposite first and second surfaces, an inner edge, and an outer edge, the first surface including a pair of circumferentially opposed clips along the outer edge and extending in an axial direction away from the first surface.

8. The pass through assembly confirmation quick connector of claim 7, wherein the locking ring includes two circumferentially opposed clip receivers, the clips of the confirmation ring being connectable to the clip receivers of the locking ring to secure the confirmation ring to the locking ring.

9. The pass through assembly confirmation quick connector of claim 7, wherein the confirmation ring includes a pair of circumferentially opposed verification tabs along the outer edge and extending in an axial direction away from the first surface.

10. The pass through assembly confirmation quick connector of claim 9, wherein the locking ring includes two circumferentially opposed tab receivers, the verification tabs of the confirmation ring being insertable into the tab receivers of the locking ring.

11. The pass through assembly confirmation quick connector of claim 7, wherein the confirmation ring includes a pair of circumferentially opposed stop tabs along the inner edge and extending in an axial direction away from the first surface.

12. The pass through assembly confirmation quick connector of claim 11, wherein the stop tabs of the confirmation ring are insertable into a portion of the twist-lock mount to prevent the locking ring from moving from the locked position to the unlocked position.

13. The pass through assembly confirmation quick connector of claim 1, wherein the confirmation ring is disk-shaped.

14. The pass through assembly confirmation quick connector of claim 1, wherein the pass through tube includes an annular flange extending radially from the cylindrical outer surface, and a sealing ring is adjacent the annular flange.

15. The pass through assembly confirmation quick connector of claim 1, including a cooperative indication surface partly formed on the locking ring and partly formed on the confirmation ring, wherein the part of the indication surface on the locking ring is adjacent to and aligned with the part of the indication surface on the confirmation ring when the confirmation ring is connected to the locking ring.

16. The pass through assembly confirmation quick connector of claim 1, wherein the pass through tube includes connectors at each end, a first quick connect component being connected to the connectors at one end; and a second quick connect component being connected to the connectors at the other end.

17. A pass through assembly, comprising:
the pass through assembly confirmation quick connector of claim 1;
a surface member having first and second sides and including an opening sized to receive the pass through tube;
the pass through tube being inserted into the opening;
the locking ring being disposed on the pass through tube in the unlocked position, wherein twisting the locking ring moves the locking ring to the locked position and draws the locking ring against the first side of the surface member and simultaneously urges a portion of the pass through tube against the second side of the surface member; and
the confirmation ring being connected to the locking ring to secure the locking ring in the locked position.

18. The pass through assembly of claim 17, wherein the surface member is one or more of a housing wall, a boundary wall, and a mounting plate.

19. A method for establishing fluid communication through a surface member having first and second sides and including an opening sized to receive the pass through tube, the method comprising:
providing the pass through assembly confirmation quick connector of claim 1;
inserting the pass through tube into the opening such that an annular flange extending radially from the cylindrical outer surface of the pass through tube abuts against the second side of the surface member;
sliding the locking ring onto the pass through tube;
twisting the locking ring approximately 90 degrees relative to the pass through tube to move the locking ring from the unlocked position to the locked position, whereby the locking ring is drawn against the first side of the surface member and the annular flange of the pass through tube is simultaneously urged against the second side of the surface member to tightly connect the pass through tube to the opening in the surface member; and
when the locking ring is in the locked position, connecting the confirmation ring to the locking ring to secure the locking ring in the locked position.

20. The method of claim 19, wherein a cooperative indication surface is partly formed on the locking ring and partly formed on the confirmation ring; and
when the confirmation ring is connected to the locking ring, the part of the indication surface on the locking ring is adjacent to and aligned with the part of the indication surface on the confirmation ring, whereby the indication surface is readable by a reader and indicates that the locking ring is securely in the locked position.
